(19) United States
(12) Patent Application Publication
(10) Pub. No.: US 2008/0139025 A1
(43) Pub. Date: Jun. 12, 2008

(54) Multi-conductor cable assembly and cable assembly for use in audio, video and multimedia applications

(76) Inventor: Friedemann Becker, Berlin (DE)

Correspondence Address: THELEN REID BROWN RAYSMAN & STEINER LLP, P.O. BOX 640640, SAN JOSE, CA, 95164-0640, US

(21) Appl. No.: 11/953,016

(22) Filed: Dec. 8, 2007

Related U.S. Application Data
(60) Provisional application No. 60/869,120, filed on Dec. 8, 2006.

(30) Foreign Application Priority Data
Dec. 8, 2006 (DE) 10200605910460139

(51) Int. Cl. H01R 3/00

(52) U.S. Cl. 439/164

(57) ABSTRACT

A multi-conductor cable assembly and a cable assembly for use in audio, video and/or multimedia applications, which can be used to facilitate connection of additional devices to a disk jockey system, a video or multimedia system, or another system in the entertainment field. A multi-conductor cable assembly includes at least one Y-cable and at least one single cable, wherein at least one Y-cable and at least one single cable are combined in a cable harness and electrically isolated from one another. A system for use in audio, video and/or multimedia applications includes at least one signal source, such as a turntable, and a mixer, and is characterized in that at least a portion of signal outputs of the signal source is connected to signal inputs of the mixer, and that the system also includes an interface for connecting additional devices, wherein the interface provides connections to a portion of the signal outputs of the signal source connected to signal inputs of the mixer, and to signal inputs of the mixer that are not connected to signal outputs of the signal source.

### CROSS REFERENCE TO RELATED APPLICATIONS

This application claims priority to and incorporates by reference German patent application no. 10-2006-059 104.6 013 991.7 filed Dec. 8, 2006.

### FIELD OF THE INVENTION

The invention relates to a multi-conductor cable assembly and a cable assembly for use in audio, video and multimedia applications, and more particularly, to readily connect additional devices to a disk jockey setup (hereinafter referred to as DJ setup), a video or multimedia system or another system from the entertainment field.

### BACKGROUND

Conventional DJ setups in the entertainment field are implemented as three different types:
Traditional DJ Setups: pre-installed DJ setups with standardized playback devices (turntables, CD players),
Digital DJ setups: genuine computer DJ setups (hereinafter therefore referred to as Computer DJ Setup), and
Hybrid DJ setups: pre-installed DJ setups enhanced by mobile audio sources and audio processors (e.g., computers, effect devices).

A traditional DJ setup includes, for example, the following components depicted in FIG. 1:
At least two (independent) audio sources, for example turntable(s) and/or CD player, which have only audio outputs,
Optionally also audio processors, which have both audio inputs and outputs and attain certain audio effects by transforming the audio signals,
A so-called sound system, for example a power amplifier and/or a loudspeaker system, and
A mixer which is connected to all the aforementioned components and hence connects these components with one another.

More recently, digital DJ setups have been introduced, which are connected to a computer that can be used with suitable audio-processing software both as an audio source and as an audio processor. This digital audio source is connected to the mixer instead of to the audio source used with a traditional DJ setup. This is accomplished via a so-called audio interface. Unlike the audio source used in a traditional DJ setup, an audio interface has typically both a signal input and a signal output and may therefore also have to be connected to the audio outputs of the mixer in addition to the audio inputs of the mixer (see FIG. 2).

Thirdly, so-called hybrid DJ setups exist which represent a combination of a traditional and a digital DJ setup (see FIG. 3). In particular, in hybrid setups the audio signals of different audio sources are used by the additionally connected computer to process the signals with audio software and to return the changed, processed signals to the mixer, or to control the reproduction of the computer-internal playback software. As a result, the audio inputs of the additionally connected computer must not only be connectable to the audio outputs of the audio mixer, but must also be able to receive the audio signals from the various audio sources in the DJ setup.

Traditional DJ setups are typically preinstalled at the venues. A “traditional DJ” brings his own records and CDs, but uses the preinstalled traditional DJ setups at the venue.

Because digital DJ setups have only been used recently, there isn't yet an established standard for the equipment which a “digital DJ” can expect to find at the venue.

A typical setup therefore is a hybrid DJ setup, where a “digital DJ” brings his own computer with sound card/audio interface to the event, which he must then connect to the preinstalled traditional DJ setup. This typically creates significant problems, because this is typically done under poor illumination conditions, so that the corresponding plugs and the like cannot be easily identified. The connectors on the existing mixer are sometimes also difficult to reach. Moreover, the computer and audio interface must be connected to a traditional DJ setup while a music title is palying, without interrupting the program when a DJ team changes. Another problem is that each change in the configuration of the preinstalled sound system requires a separate sound check, because mistakes can be easily made when the system is rewired.

Another problem is that typically a “digital DJ” is not the only artist connected to the DJ system during an event. He must share the DJ system with other DJs, typically with “traditional DJs.” As a result, he must connect his digital system with the DJ system—typically while the program is ongoing—, without interfering with the existing connections between the audio sources and the mixer of the existing traditional DJ setup.

Because of these problems, it would be desirable to simplify the connection between a “digital DJ” and a traditional system.

### SUMMARY

It is therefore an object of the present invention to provide a multi-conductor cable assembly and a cable assembly for use in audio, video and/or multimedia applications, which facilitates integration of additional devices in an existing audio, video and/or multimedia system.

A particular advantage of the invention is that when using the multi-conductor cable assembly of the invention, these additional devices, for example peripheral devices, can be connected to audio, video and/or multimedia systems without causing interference, while these systems are operated by other users. To this end, a multi-conductor cable assembly is proposed which can be used in such audio, video and/or multimedia system and which includes at least one Y-cable and at least one single cable. The single cable can be, for example, a symmetric audio cable or an asymmetric audio cable, for example a Chinch-cable, with an inner conductor and a shield. Depending on the application, the single cable may have only a single conductor. Preferably, the same cable material is used for the Y-cable as for the single cable. According to the invention, the at least one Y-cable and at least one single cable are independent cables, i.e., they are electrically isolated from one another, integrated into a cable unit.

Preferably, the Y-cable and the single cable, respectively, are implemented in the cable assembly and/or in the cable unit in pairs to be compatible with traditional stereo channels of the connected devices. A cable unit is to be understood hereinafter as a combination of several cables into an object: such as the combination (at least partially) in a cable harness or cable bundle, a separable or inseparable combination of several cables in a common plug (housing) or in a common receptacle, and the like.

In a preferred embodiment of the cable assembly of the invention, the Y-cable(s) and single cable(s) form a common cable harness at least over a portion of their length.

According to another preferred embodiment of the invention, the ends of the Y-cable(s) and single cable(s) include connecting elements, such as stereo plugs, RCA plugs and/or XLR plugs or jacks or other standard plugs or jacks. Preferably, at least the connecting element at the end of the Y-cable terminating in a single cable and the connecting element at an end of the single cable are integrated in a common housing, for example a multipolar plug. Such common housing can also include additional connecting elements, and several such common housings can again be combined into a common housing. The common housing can be located at one end of the cable unit or the cable assembly.

According to another preferred embodiment of the multi-conductor cable assembly, the cable assembly includes at a first end at least one signal input connecting element and at least two signal output connecting elements. These signal input and signal output connecting elements, respectively, may be in the form of plugs or jacks, suitable for applications in the field of audio, video and/or multimedia, such as so-called XLR plugs and jacks, so-called stereo plugs or so-called RCA plugs or jacks. The second end of the multi-conductor cable assembly of the invention includes furthermore at least one signal input connecting element and at least one signal output connecting element. According to the invention, at least one of the signal input connecting elements at the first end of the multi-conductor cable assembly is connected to at least one of the signal output connecting elements at the second end. In addition, at least one first of the at least two signal output connecting elements at the first end is connected to at least one of the signal input connecting elements at the second end by way of electrically conducting connecting means, for example coaxial cables or other wire or cable connections.

According to the invention, the multi-conductor cable assembly provides at its first end a particular connection of the signal input and/or signal output connecting elements. According to the invention, at least one of the signal input connecting elements at the first end of the multi-conductor cable assembly, which is connected to one of the signal output connecting elements at the second end, is additionally connected to at least one second of the at least two signal output connecting elements of this first end. This type of connection according to the invention is particularly advantageous if the connecting elements at the first end of the multi-conductor cable assembly are connected to the systems of a DJ setup, for example turntable, CD player or a mixer, or also with devices from the video or multimedia technology, for example video recorder, beamer, multimedia computer and the like. In this case, at least a portion of the devices connected to the connecting elements at the first end can be connected to one another—and remain connected, even while other devices are connected to or removed from the second end of the cable assembly.

In a preferred embodiment of the invention, the connecting elements at the first end of the cable assembly of the invention are connected to the outputs of an audio source, such as a turntable or a CD player, or with the inputs of a mixer. In such an arrangement, the audio signals supplied by the audio source are simultaneously looped to the inputs of the mixer and are present at the signal output connecting elements at the second end of the cable assembly of the invention. The connecting elements at the second end of the cable assembly of the invention can now be used to connect additional devices, which receive and optionally process the audio signals present at the signal output connecting elements at the second end of the cable assembly, and which in turn provide audio signals to the signal outputs which are transmitted from the signal input connecting elements at the second end of the cable assembly of the invention via signal output connecting elements of the cable assembly to devices of the DJ setup, for example a mixer.

Advantageously, the aforedescribed cable assembly of the invention is duplicated for connecting the left and right stereo channel of the devices connected to the cable assembly of the invention accordingly. A preferred embodiment of such solution is configured as follows:

The first end includes
at least two signal input connecting elements, and
at least four signal output connecting elements,
   and the second end includes
at least two signal input connecting elements, and
at least two signal output connecting elements.
   At least two of the signal input connecting elements of the first end are connected to at least two of the signal output connecting elements at the second end, and at least a first and a second of the at least four signal output connecting elements of the first end are connected to at least two of the signal input connecting elements of the second end. Moreover, at least two of the signal input connecting elements of the first end are connected to at least one third and fourth of the at least four signal output connecting elements at the first end via electrically conducting connecting means.

According to a preferred embodiment of the last-described invention configured for stereo systems, at least six of the signal input and/or signal output connecting elements at the first end are connected to three stereo channels, whereas four of the signal input and signal output connecting elements at the second end are connected to two stereo channels of connected devices.

According to another preferred embodiment of the cable assembly of the invention, the connecting elements at the second end are at least partially integrated in a common housing. Such common housing can be implemented, for example, as an edge connector; however, the common housing is preferably implemented as a multipolar plug or a multipolar jack. Alternatively, several housings can also be provided which operate as a common housing for several connecting elements. Advantageously, when employing several common housings, at least one signal input connecting element and at least one signal output connecting element, preferably however at least two signal input elements and at least two signal output elements, are integrated in the common housings.

Advantageously, at least a portion of the connecting elements at the first end of the cable assembly are implemented as a breakout cable. The connecting elements, which terminate in a breakout cable, can be used to connect a large number of devices. The cable arrangement of the invention can thereby be connected to several devices at different locations. The devices to be connected therefore do not need to be placed in a specific arrangement. This is particularly advantageous when using the cable assembly of the invention for DJ setup at different venues, because the DJ setups at the different venues can be configured in different ways.

One particular arrangement according to the invention includes at least a source of audio, video and/or multimedia signals (hereinafter also referred to as a signal source) and means for processing audio, video and/or multimedia signals (hereinafter referred to as processing means). According to the invention, the signal source and the processing means are connected to one another by the connecting elements at the first end (preferably implemented as a breakout cable) of the cable assembly of the invention. At least a portion of the signal outputs of the at least one signal source are connected via electrically conducting connections, such as audio cables and the like, with the signal inputs of the processing means. The arrangement also includes at least one interface for connecting additional devices. This interface is formed by the second end of the cable assembly of the invention. The cable assembly of the invention is here connected to the signal source and processing means so that at least a portion of the signal outputs of the signal source, which is already connected to the signal inputs of the processing means, is also connected to the interface, so that the interface provides an (electrically conducting) access point for other devices, such as an audio interface or other devices or systems employed in audio, video and/other multimedia applications, to these (already connected) signal outputs of the signal source. The interface also provides access to those signal inputs of the processing means that are not already connected directly to signal outputs of the signal source. Additional electrically conducting connections can also be provided.

According to another preferred embodiment of the cable assembly of the invention, the cable assembly is constructed in two parts. In the two-part cable assembly, the connecting elements at the first end of the cable assembly of the invention are combined in a first section of the cable assembly. A second section of the two-part cable assembly of the invention includes the connecting elements at the second end of the cable assembly. The two sections of the two-part cable assembly of the invention are connected to one another via one or several electrically conducting connections in such a way that the connecting elements of the first and second section (these are the connecting elements of the first and second end of the cable assembly of the invention) are connected to one another. Advantageously, by using an electrically conducting connection, connecting second section becomes less complex. Preferably, the electrically conducting connection of the two sections of the cable assembly is implemented as a releasable connection. In a particularly preferred embodiment, the releasable connection includes one or more plug connections, for example one or more plug connections constructed with XLR plug(s) and XLR jack(s).

According to another preferred embodiment of the two-part cable assembly of the invention, the first section of the two-part cable assembly is formed by a cable assembly of the invention. According to a particularly preferred embodiment, the cable assembly of the invention is used as the first section of the two-part cable connection. Preferably, the connecting elements of this cable assembly at the first end form a breakout cable, whereas the second end is formed by one or more common housings of the aforedescribed type, in which the connecting elements at the second end of the cable assembly are combined, which is used as the first section of the two-part cable assembly.

Advantageously, the second section of the two-part cable assembly is implemented as a cable assembly, whose connecting elements (at the second end) form a breakout cable and whose electrically conducting connection interfaces with the electrically conducting connection of the first section. Preferably, the electrically conducting connection is implemented as an XLR plug and a corresponding XLR jack.

In an exemplary embodiment, the second section is constructed as a standard multi-conductor cable, i.e., each connecting element is connected to (exactly) one contact (e.g., a pin) of the electrically conducting connection. This two-part construction of the cable assembly of the invention is advantageous because the first section of the two-part cable assembly can be used to connect those devices which are fixedly installed at the venues, for example a traditional DJ setup with turntable, CD player and mixer. When using the first section of the two-part cable assembly, the audio sources, meaning turntable and/or CD player, are connected to other stationary devices at the venue, for example a mixer or other means for processing (mixing, superimposing, distorting and the like) audio, video and/or multimedia signals. The electrically conducting connection of the first section of the cable assembly of the invention provides a kind of interface for peripheral devices, for example for an audio interface of a data processing device or a sound card of a “digital DJ”, to the devices that are installed at the venue, for example a traditional DJ setup. This interface, i.e., the electrically conducting connection of the first section of the cable assembly, can now be used with the second section of the cable assembly of the invention to easily connect peripheral devices to the existing system, without interfering with the installation and operation of the fixedly installed system.

Advantageously, several artists performing at an event in succession can connect or disconnect their respective peripheral devices, for example a digital audio source, such as a sound card or the like, from the existing system. The only requirement is that the connecting elements of the second section of the cable assembly of the invention are connected as intended with one or more peripheral devices. The preinstalled peripheral devices can then be easily connected by a single operation to the existing system via the electric of the conducting connection. When peripheral devices are interchanged, the fixedly installed system can continue to operate without disruption, because the signals of at least a portion of the fixedly installed audio source are looped through the electrically conducting connecting means of the first section of the cable assembly of the invention to the desired devices, for example to a mixer.

With the invention, a cable assembly can be provided to a “digital DJ” which allows him to readily connect to a traditional DJ setup, without affecting the existing connections between the audio sources and the mixer that were set up by a “traditional DJ” using the same DJ setup.

### BRIEF DESCRIPTION OF THE DRAWINGS

The invention will now be described in detail with reference to an exemplary embodiment illustrated at least in part in the Figures.

FIG. 1 shows a traditional DJ setup;

FIG. 2 shows a digital DJ setup;

FIG. 3 shows a hybrid DJ setup;

FIG. 4 is a diagram of an exemplary two-part audio cable; and

FIG. 5 illustrates a peripheral device connected to a traditional DJ setup with a two-part cable assembly according to the invention.

### DETAILED DESCRIPTION

The invention will now be described with reference to an exemplary cable arrangement implemented as a two-part audio cable which is used to connect a digital audio source to a traditional DJ setup. However, the invention is not limited to the use of an audio cable in DJ setups, but can also be used to connect peripheral devices via other cable assemblies according to the invention to other audio, video and/or multimedia devices.

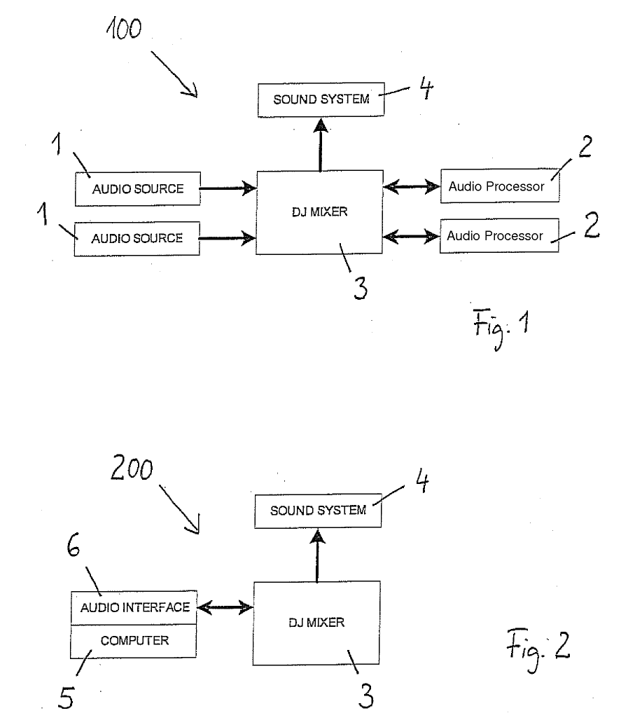

At most venues, so-called hybrid DJ setups 300 have been used for quite some time. These include essentially a combination of a traditional DJ setup 100 which typically includes one or more audio sources 1, audio processors 2, which transform audio signals to generate special effects, a mixer 3 and a sound system 4, consisting of a power amplifier and a loudspeaker system (see FIG. 1), with a genuine computer DJ setup 200.

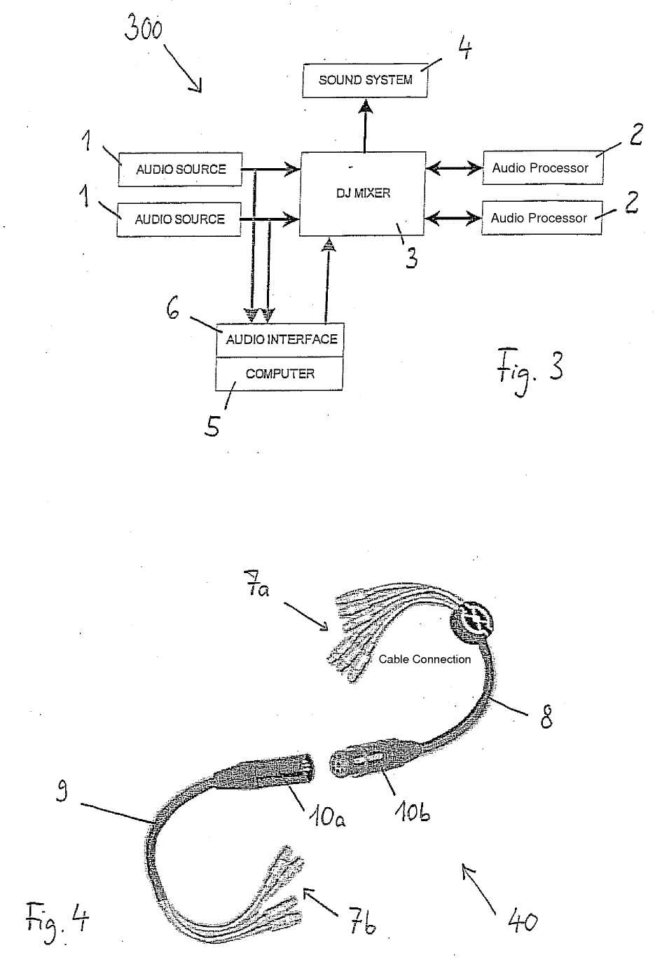

A genuine computer DJ setup 200 typically includes as an audio source a computer 5 with an audio interface 6, a mixer 3 and a sound system 4 (see FIG. 2). A signal output of the mixer is connected to the sound system 4. In a computer DJ setup 200, the mixer 3 has both a signal input and a signal output for connecting the audio interface 6. A hybrid DJ setup 300 represents a combination of a traditional DJ setup 100 and a computer DJ setup 200. The audio interface 6 and the computer 5 are connected to the traditional DJ setup 100 in such a way that the outputs of the audio sources 1 of the traditional DJ setup 100 are connected to the signal inputs of the audio interface 6, and a signal output of the audio interface 6 is connected to a signal input of the mixer 3 (see FIG. 3).

The traditional DJ setups 100 are, as mentioned above, typically preinstalled at the venues. Conversely, “digital DJs” tend to bring their own computer 5 with the audio interface 6 to the venue, where they must be connected to the preinstalled traditional DJ setup 100. For the aforementioned reasons, this approach is quite complex and error-prone when using current technology.

The use of the invention in a hybrid DJ setup 300 will now be described with reference to an exemplary two-part audio cable 40.

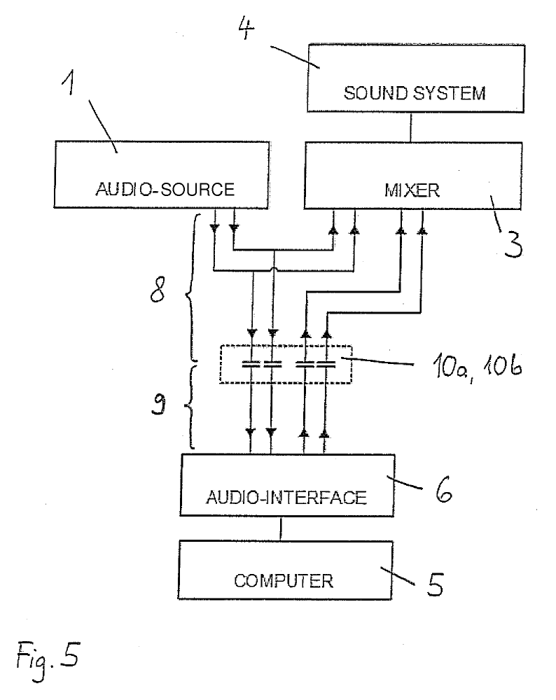

The exemplary audio cable 40 and its use in a DJ setup will be described with reference to FIGS. 4 and 5. The exemplary audio cable 40 has a first section 8 on the setup-side and a second section 9 on the sound card-side. In one exemplary embodiment, the section 8 on the setup-side has two RCA jacks and four RCA plugs as connecting elements 7a, while the section 9 on the sound card-side has four RCA plugs as connecting elements 7b. In an exemplary embodiment, both sections of the two-part audio cable are connected to one another via a 7-pin XLR plug connection 10a, 10b.

The connecting elements 7a of the section 8 on the setup-side are connected to the signal outputs of one or several audio sources 1 and the signal inputs of a mixer 3 of the traditional DJ setup 100 installed at the venue. The exemplary audio cable 40 is constructed so that a traditional DJ setup 100 can be converted into a hybrid DJ setup 300. The exemplary audio cable 40 connects, when connected in the described manner to the components of a traditional DJ setup 100, the signal outputs of the audio source 1 with signal inputs of the audio interface 6 of the “digital DJ” and the signal outputs of the audio interface 6 of the “digital DJ” with signal inputs of the mixer 3 installed at the venue. The computer 5 and the audio interface 6 of the “digital DJ” are then connected to the traditional DJ setup 100 installed at the venue (see FIG. 5). Moreover, the setup-side section 8 of the exemplary audio cable 40 connects the audio source 1 and the mixer 3. If the exemplary audio cable 40 is already preinstalled in the traditional DJ setup 100, for example because the organizer supplies the audio cable to the “digital DJs” as an interface for their equipment (computer 5 and audio interface 6), then additional connecting cables between the components of the traditional DJ setup 100 are typically no longer required. With the invention, the cabling complexity can be drastically reduced. The setup-side section 8 of the exemplary audio cable 40 can therefore also be used in a traditional DJ setup 100 as a passive connection between the components (decks and mixer) of a traditional DJ setup 100 alone, without the sound card-side section 9.

Connecting the equipment, i.e., the computer 5 and the audio interface 6, to the setup-side section 8 of the exemplary audio cable 40 which has already been connected to the traditional DJ setup 100, only requires that the “digital DJ” connects the inputs and outputs of the audio interface 6 with the connecting elements 7b of the sound card-side section 9 of the exemplary audio cable 40. Only the two sections 8, 9 of the exemplary audio cable 40 need then be connected with the XLR-plug 10a and the XLR-jack 10b to connect the system of the “digital DJ” to the traditional DJ setup 100 for configuring a hybrid DJ setup 300. Equipment of “digital DJs”, which is connected to a traditional DJ setup 100 with an exemplary audio cable 40, can be easily disconnected from the traditional DJ setup 10 simply by disconnecting the plug connection formed by XLR-plug 10a and the XLR-jack 10b.

The implementation of the invention is not limited to the aforedescribed preferred exemplary embodiments. Instead, a number of modifications can be contemplated which make use of the cable assembly of the invention in entirely different embodiments.

### LIST OF REFERENCE SYMBOLS

1 audio source

2 audio processor

3 mixer

4 sound system

5 computer

6 audio interface

7a connecting elements

7b connecting elements

8 setup-side section

9 sound card-side section

10a XLR-plug

10b XLR-jack

100 traditional DJ setup

200 computer DJ setup

300 hybrid DJ setup

400 audio cable

What is claimed is:

1. A multi-conductor cable assembly for use in at least one of audio, video and multimedia applications, comprising:
at least one Y-cable and at least one single cable, wherein at least one Y-cable and at least one single cable are electrically isolated from one another and combined in a cable unit,
characterized in that
a first end of the multi-conductor cable assembly comprises two ends of the Y-cable and a first end of the single cable and
a second end of the multi-conductor cable assembly comprises the third end of the Y-cable and the second end of the single cable, and that
at the first end of the multi-conductor cable assembly a first end of the both ends of the Y-cable comprises a signal input connecting element and the second end of the both ends of the Y-cable comprises a signal output connecting element.

2. The multi-conductor cable assembly according to claim 1, further comprising a first end with
at least one signal input connecting element, and
at least two signal output connecting elements,
a second end with
at least one signal input connecting element, and
at least one signal output connecting element,
and electrically conducting connecting means which connect at least one of the signal input connecting elements at the first end to at least one of the signal output connecting elements at the second end, and which further connect at least a first of the at least two signal output connecting elements at the first end to at least one of the signal input connecting elements at the second end,
wherein at least one of the signal input connecting means at the first end is connected to at least a second of the at least two signal output connecting means at the second end.

3. The multi-conductor cable assembly according to claim 1, wherein at least a subset of the signal input and output connecting elements at the second end are integrated in a common housing.

4. The multi-conductor cable assembly according to claim 3, wherein the common housing is implemented as a multipolar plug or a multipolar jack.

5. The multi-conductor cable assembly according to claim 1, wherein the signal input connecting elements and signal output connecting elements at the first end are implemented as
RCA plugs or RCA jacks or
stereo jacks, or a combination thereof.

6. The multi-conductor cable assembly according to claim 1, wherein at the first end of the cable assembly forms a breakout cable.

7. The multi-conductor cable assembly according claim 1, wherein the cable assembly is constructed in two sections, wherein a first section of the cable assembly comprises the signal input and signal output connecting elements at the first end of the cable assembly, wherein a second section of the cable assembly comprises the signal input and signal output connecting elements at the second end of the cable assembly, and wherein the signal input and signal output connecting elements at the first and second end are connected to one another by releasable electrically conducting connection means.

8. The multi-conductor cable assembly according to claim 7, wherein the first section of the cable assembly comprises a multi-conductor cable assembly.

9. The multi-conductor cable assembly according to claim 1, wherein at least a subset of the signal input and signal output connecting elements at the first end of the cable assembly is connected to at least one of an audio, video and multimedia source and to at least one processor for processing several audio, video or multimedia signals, or combinations thereof.

10. The multi-conductor cable assembly according to claim 9, wherein the at least one audio source is a turntable or a CD player, and the at least one processor is a mixer.

11. The multi-conductor cable assembly according to claim 7, wherein the second section of the cable assembly is connected to at least one digital audio source by the signal input and signal output connecting elements disposed at the second end of the cable assembly.

12. The multi-conductor cable assembly according to claim 11, wherein
the at least one digital audio source comprises a sound card or an audio interface of a data processing system, or both.

13. A multi-conductor cable assembly for use in at least one of audio, video and multimedia applications, comprising
at least two Y-cables and at least two single cables integrated in one cable unit and electrically isolated from one another.

14. The multi-conductor cable assembly according to claim 13, further comprising
a first end with
at least two signal input connecting elements, and
at least four signal output connecting elements,
a second end with
at least two signal input connecting elements, and
at least two signal output connecting elements,
wherein at least two of the signal input connecting elements at the first end are connected to at least two of the signal output connecting elements at the second end, and at least a first and a second of the at least four signal output connecting elements at the first end are connected to at least two of the signal input connecting elements at the second end, and
electrically conducting connecting means which connect at least two of the signal input connecting elements at the first end to at least a third and a fourth of the at least four signal output connecting elements at the first end.

15. The multi-conductor cable assembly according to claim 14, wherein the first end comprises at least six signal input connecting elements or signal output connecting elements and the second end comprises at least four signal input connecting elements or signal output connecting elements, wherein six of the signal input connecting elements or signal output connecting elements at the first end are assigned to three stereo channels and four of the signal input connecting elements or signal output connecting elements at the second end are assigned to two stereo channels.

16. The multi-conductor cable assembly according to claim 13, wherein
at least a subset of the signal input and output connecting elements at the second end are integrated in a common housing.

17. The multi-conductor f cable assembly according to claim 16, wherein the common housing is implemented as a multipolar plug or a multipolar jack.

18. The multi-conductor cable assembly according to claim 13, wherein
the signal input connecting elements and signal output connecting elements at the first end are implemented as
RCA plugs or RCA jacks or
stereo jacks, or a combination thereof.

19. The multi-conductor cable assembly according to claim 13, wherein
at least a subset of the connecting elements at the first end forms a breakout cable.

20. The multi-conductor cable assembly according claim 13, wherein the cable assembly is constructed in two sections, wherein a first section of the cable assembly comprises the signal input and signal output connecting elements at the first end of the cable assembly, wherein a second section of the cable assembly comprises the signal input and signal output connecting elements at the second end of the cable assembly, and wherein the signal input and signal output connecting elements at the first and second end are connected to one another by releasable electrically conducting connection means.

21. The multi-conductor cable assembly according to claim 20 wherein the first section of the cable assembly comprises a multi-conductor cable assembly.

22. The multi-conductor cable assembly according to claim 13, wherein
at least a subset of the signal input and signal output connecting elements at the first end of the cable assembly is connected to at least one of an audio, video and multimedia source and to at least one processor for processing several audio, video or multimedia signals, or combinations thereof.

23. The multi-conductor cable assembly according to claim 22, wherein
the at least one audio source is a turntable or a CD player, and the at least one processor is a mixer.

24. The multi-conductor cable assembly according to claim 20, wherein
the second section of the cable assembly is connected to at least one digital audio source by the signal input and signal output connecting elements disposed at the second end of the cable assembly.

25. The multi-conductor cable assembly according to claim 24, wherein
the at least one digital audio source comprises a sound card or an audio interface of a data processing system, or both.

26. A system for connecting at least one signal source selected from the group of audio, video and multimedia signals to a processing means for processing the audio, video or multimedia signals, wherein
at least a subset of signal outputs of the at least one signal source is connected to signal inputs of the processing means in such a way that the connection is established by the medium of the two ends of the Y-cable comprised in the first end of the multi-conductor cable assembly according to claim 1, and wherein
the second end of the multi-conductor cable assembly provides an interface for connecting further devises, where the interface is further connected via the single cable of the multi-conductor cable assembly with at least a subset of signal inputs of the processing means, which are not connected with signal outputs of the at least one signal source.

27. A system for connecting at least one signal source selected from the group of audio, video and multimedia signals to a processing means for processing the audio, video or multimedia signals, wherein at least a subset of signal outputs of the at least one signal source is connected to signal inputs of the processing means in such a way that the connection is established by the medium of the two ends of the Y-cable comprised in the first end of the multi-conductor cable assembly according to claim 13, and wherein
the second end of the multi-conductor cable assembly provides an interface for connecting further devises, where the interface is further connected via the single cable of the multi-conductor cable assembly with at least a subset of signal inputs of the processing means, which are not connected with signal outputs of the at least one signal source.
